(19) United States
(12) Patent Application Publication
(10) Pub. No.: US 2005/0225228 A1
(43) Pub. Date: Oct. 13, 2005

(54) Field electron emission materials and devices

(76) Inventors: Adrian Paul Burden, Singapore (SG); Hugh Bishop, Abingdon (GB); Warren Lee, Reading (GB)

Correspondence Address: BARNES & THORNBURG, P.O. BOX 2786, CHICAGO, IL, 60690-2786, US

(21) Appl. No.: 10/508,985

(22) PCT Filed: Mar. 24, 2003
(86) PCT No.: PCT/EP03/50078

§ 371 Date: May 18, 2005

(30) Foreign Application Priority Data
Mar. 25, 2002 (GB) 0206984.7

(51) Int. Cl. H01J 1/62; H01J 63/04

(52) U.S. Cl. 313/495

(57) ABSTRACT

In a method of creating a field electron emission material, vanadium or a vanadium compound is disposed in respective locations of a substrate in order to create a plurality of emission site at said locations, at an average density of at least ¹⁰cm^{-2.}Preferably, the vanadium or vanadium compound is in the form of particles.

This invention relates to field electron emission materials, and devices using such materials.

In classical field electron emission, a high electric field of, for example, ≈3×10⁹ V m⁻¹ at the surface of a material reduces the thickness of the surface potential barrier to a point at which electrons can leave the material by quantum mechanical tunnelling. The necessary conditions can be realised using atomically sharp points to concentrate the macroscopic electric field. The field electron emission current can be further increased by using a surface with a low work function. The metrics of field electron emission from metals are described by the well-known Fowler-Nordheim equation.

There is considerable prior art relating to electron emitters and emitting arrays which utilise field electron emission from sharp points (tips). The main objective of workers in the art has been to place an electrode with an aperture (the gate) less than 1 micrometer away from each single emitting tip, so that the required high fields can by achieved using applied potentials of 100 V or less—these emitters are termed gated arrays. The first practical realisation of this was described by C A Spindt, working at Stanford Research Institute in California (J.Appl.Phys. 39,7, pp 3504-3505, (1968)). Since then, improvements to such emitter arrays have been suggested, including doping the bulk and surface of the tips with electropositive elements (U.S. Pat. No. 5,772,488).

Major problems with all tip-based emitting systems are their vulnerability to damage by ion bombardment, ohmic heating at high currents, the catastrophic damage produced by electrical breakdown in the device and the fact that making large area devices is both difficult and costly.

In about 1985, it was discovered that thin films of diamond could be grown to provide nominally flat field emitters—that is, field emitters that do not require deliberately engineered tips. Wang et al reported (Electron. Lett., 27, pp 1459-1461 (1991)) that field electron emission current could be obtained from broad area diamond films with electric fields as low as 3 MV m⁻¹. This performance is believed by some workers to be due to a combination of the low electron affinity of the (111) facets of diamond and the high density of localised, accidental graphite inclusions (Xu, Latham and Tzeng: Electron. Lett., 29, pp 1596-159 (1993)) although other explanations have been proposed. Soon after, carbon nanotubes (CNTs) were found to be exemplary field emitting structures. Not only was their growth in a high electric field explained by realising that these structures would field emit (Colbert et al.: Science, 266, pp 1218-1222 (1994)), but electron sources comprising CNTs were reported (Rinzler et al.: Science, 269, pp1550-1553 (1995)).

Major problems with purely carbon based emitting systems are their vulnerability to damage by oxidation, and the fact that some carbon-based films are metastable and incompatible with the vacuum bake-out and sealing processes required to make a technologically useful field emitting device. In addition, CNTs are difficult to incorporate into devices because their bulk growth process generates a tangled bundle of a variety of different types of nanotube that are difficult to separate and purify. The alternative approach of using an in-situ catalytic growth technique is inferior because it has not yet been possible to find conditions that yield the highly crystalline single walled nanotube structures (or indeed multi-walled nanotube structures comprising only ten or so graphene layers) that provide the best field emission properties. Instead the structures are relatively large diameter carbon fibres or stubs with less ordered graphitic layers.

Work has been carried out to study-and avoid-the mechanisms associated with electrical breakdown between electrodes in vacuum (e.g. Latham and Xu, Vacuum, 42,18, pp 1173-1181 (1991)), in which electrons are known to leave relatively flat surfaces at active sites that are metal-insulator-vacuum (MIV) structures. These are formed by either embedded dielectric particles or conducting flakes sitting on insulating patches such as the surface oxide of the metal. This is well described in the scientific literature e.g. Latham, High Voltage Vacuum Insulation, Academic Press (1995). In a similar vein, it was more recently reported by Werner et al. (Particle Accelerator Conference, 2001), that spiky particles of milled vanadium on copper or niobium cathodes formed unwanted sites of electrical breakdown and high field emission current densities.

It is to be appreciated that the emitting sites referred to in such works are unwanted defects, occurring sporadically in small numbers, and the main objective in vacuum insulation work is to avoid them. For example, as a quantitative guide, there may be only a few such emitting sites per cm², and only one in 10³ or 10⁴ visible surface defects will provide such unwanted and unpredictable emission.

Accordingly, the teachings of such works have been adopted by a number of technologies (e.g. particle accelerators) to improve vacuum insulation.

In contrast to this, embodiments of the present invention provide emitting materials that are designed deliberately to have a significant density of emitting sites, as opposed to accidental and unwanted sparse inclusions of sporadic emitters.

Preferred embodiments of the present invention aim to provide an improved field electron emitter material that can be incorporated into a device structure, has advantages similar to those of carbon nanotubes, and can also be uniformly, controllably and inexpensively applied to a substrate and then air and vacuum fired to effect a sealed device.

Preferred embodiments of the present invention aim to provide improved field electron emitting materials and devices that may be used in devices that include (amongst others): field electron emission display panels; high power pulse devices such as electron MASERS and gyrotrons; crossed-field microwave tubes such as CFAs; linear beam tubes such as klystrons; flash x-ray tubes; triggered spark gaps and related devices; broad area x-ray sources for sterilisation; vacuum gauges; ion thrusters for space vehicles; particle accelerators; lamps; ozonisers; and plasma reactors.

According to one aspect of the present invention there is provided a method of creating a field electron emission material, comprising the step of disposing vanadium or a vanadium compound in respective locations of a substrate in order to create a plurality of emission sites at said locations, at an average density of at least 10² cm⁻².

Preferably, said vanadium or vanadium compound is in the form of particles.

A method as above preferably includes:
an application step of applying a vanadium-containing material to said substrate; and
a processing step of processing the vanadium-containing material after application to said substrate, in order to create said emission sites.

Preferably, said processing step includes heating said vanadium-containing material.

Said processing step may include heating said vanadium-containing material to a temperature in the range 100 to 1000° C.

Said processing step may include heating said vanadium-containing material to a temperature in the range 300 to 800° C.

Said processing step may include heating said vanadium-containing material to a temperature in the range 500 to 550° C.

Said processing step may include maintaining said temperature for a period in the range 5 to 300 minutes.

Said processing step may include maintaining said temperature for a period in the range 5 to 60 minutes.

Said processing step may include maintaining said temperature for a period in the range 10 to 30 minutes.

Preferably, said processing step includes forming whiskers of said vanadium or vanadium compound.

Said application step preferably includes printing said vanadium-containing material directly or indirectly onto said substrate.

Said application step may include printing said vanadium-containing material onto a cathode track on said substrate.

Said application step may include printing said vanadium-containing material onto a resistive layer on said substrate.

Preferably, said vanadium-containing material comprises an organometallic compound and a vanadium compound.

Preferably, said organometallic compound contains one or more metal selected from gold, palladium and platinum.

Said vanadium-containing material may contain 0.01 to 10 wt % of vanadium with respect to the metal part of the organometallic compound.

Said vanadium-containing material may contain 0.5 to 5 wt % of vanadium with respect to the metal part of the organometallic compound.

Said vanadium-containing material may contain 0.8 to 2.5 wt % of vanadium with respect to the metal part of the organometallic compound.

Said vanadium-containing material may comprise vanadium naphthenate oxide.

Said vanadium-containing material may contain material to create both said emission sites and a layer upon which said emission sites are disposed.

Said layer may provide an electrode.

Said layer may provide a resistive layer to serve as a ballast resistor.

Said processing step may comprise processing the vanadium-containing material under such conditions as to create said layer and said emission sites concurrently.

Said processing step may comprise processing the vanadium-containing material under first conditions such as to create said layer and subsequently under second conditions such as to create said emissions sites on said layer.

Said processing step may be carried out concurrently with a sealing step in which the field electron emission material is sealed within a field electron emission device.

In another aspect, the invention provides a method of creating a field electron emission material, comprising the steps of disposing a metal oxide upon a substrate and processing the metal oxide in such conditions as to grow whiskers from the metal oxide at locations on said substrate, thereby to create a plurality of emission sites at said locations.

Preferably, said emission sites have an average density of at least 10² cm⁻².

A method according to either of the two immediately preceding paragraphs may also be in accordance with any of the preceding aspects of the invention.

The invention extends to a field electron emission material that has been created by a method according to any of the preceding claims.

In another aspect, the invention extends to a field electron emission material comprising vanadium or vanadium compound applied to respective locations of a substrate in order to create a plurality of emission sites at said locations, at an average density of at least 10² cm⁻².

Preferably, said vanadium or vanadium compound is in the form of a plurality of particles.

In any of the preceding aspects of the invention, said vanadium compound may be selected from the group comprising vanadium oxide, vanadium silicide, vanadium nitride, vanadium silicate, vanadium carbide, vanadium boride, vanadium sulphide and vanadium titanate.

Preferably, the distribution of said sites over the field electron emission material is random.

Preferably, said sites are distributed over the field electron emission material at an average density of at least 10³ cm⁻², 10⁴ cm⁻² or 10⁵ cm⁻².

Preferably, the distribution of said sites over the field electron emission material is substantially uniform.

The distribution of said sites over the field electron emission material may have a uniformity such that the density of said sites in any circular area of lmm diameter does not vary by more than ²⁰% from the average density of distribution of sites for all of the field electron emission material.

The distribution of said sites over the field electron emission material when using a circular measurement area of 1 mm in diameter may be substantially Binomial or Poisson.

The distribution of said sites over the field electron emission material may have a uniformity such that there is at least a 50% probability of at least one emitting site being located in any circular area of 4 μm diameter.

The distribution of said sites over the field electron emission material may have a uniformity such that there is at least a 50% probability of at least one emitting site being located in any circular area of 10 μm diameter.

The invention extends to a field electron emission device comprising a field electron emitter containing a field electron emission material according to any of the preceding aspects of the invention, and means for subjecting said emitter to an electric field in order to cause said emitter to emit electrons.

Such a device may comprise a substrate with an array of patches of said field electron emitters, and control electrodes with aligned arrays of apertures, which electrodes are supported above the emitter patches by insulating layers.

Preferably, said apertures are in the form of slots.

A device as above may comprise a plasma reactor, corona discharge device, silent discharge device, ozoniser, an electron source, electron gun, electron device, x-ray tube, vacuum gauge, gas filled device or ion thruster.

The field electron emitter may supply the total current for operation of the device.

The field electron emitter may supply a starting, triggering or priming current for the device.

A device as above may comprise a display device.

A device as above may comprise a lamp.

Said lamp may be substantially flat.

Said emitter may be connected to an electric driving means via a ballast resistor to limit current.

Preferably, said ballast resistor is applied as a resistive pad under each said emitting patch.

Preferably, said emitter material and/or a phosphor is/are coated upon one or more one-dimensional array of conductive tracks which are arranged to be addressed by electronic driving means so as to produce a scanning illuminated line.

Preferably, said field electron emission device includes said electronic driving means.

Preferably, said field emitter is disposed in an environment which is gaseous, liquid, solid, or a vacuum.

A field electron emission device as above may comprise a cathode which is optically translucent and is so arranged in relation to an anode that electrons emitted from the cathode impinge upon the anode to cause electro-luminescence at the anode, which electro-luminescence is visible through the optically translucent cathode.

For a better understanding of the invention, and to show how embodiments of the same may be carried into effect, reference will now be made, by way of example, to the accompanying diagrammatic drawings, in which:

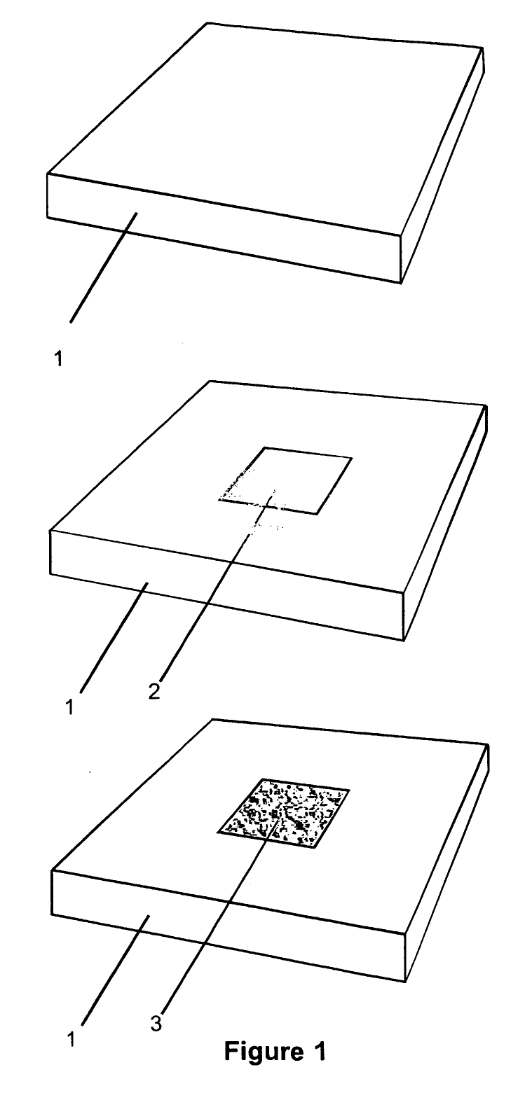

FIG. 1 shows a substrate on which is deposited a region of vanadium-containing precursor which is then heat treated to create vanadium-containing whiskers in the region where the precursor was disposed;

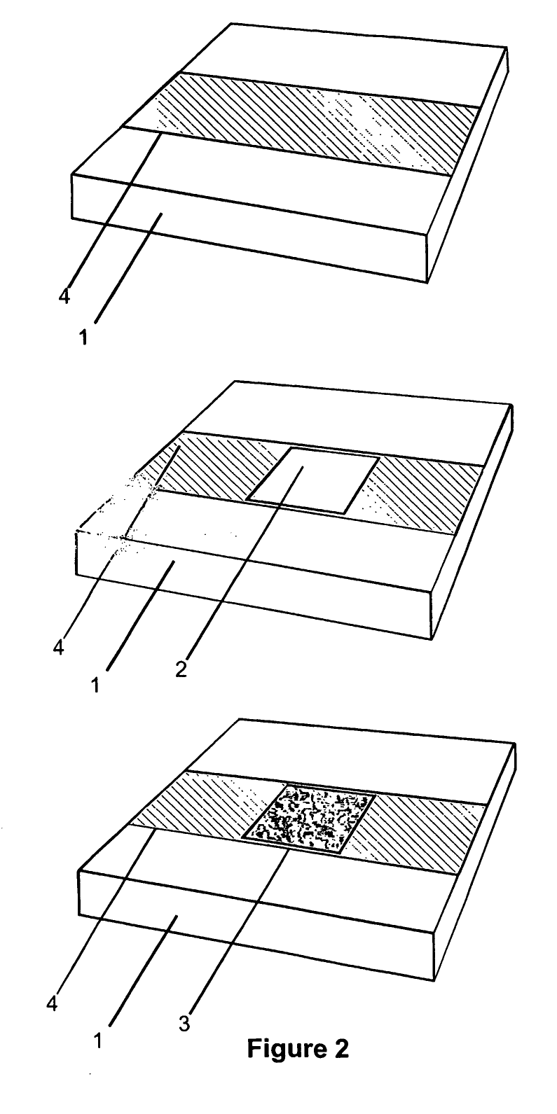

FIG. 2 shows a substrate on which is deposited a conductive track that will form a back contact electrode (cathode), followed by a vanadium-containing precursor deposited on a region of this track, and then heat treatment of the assembly to create vanadium-containing whiskers in the region where the precursor was disposed;

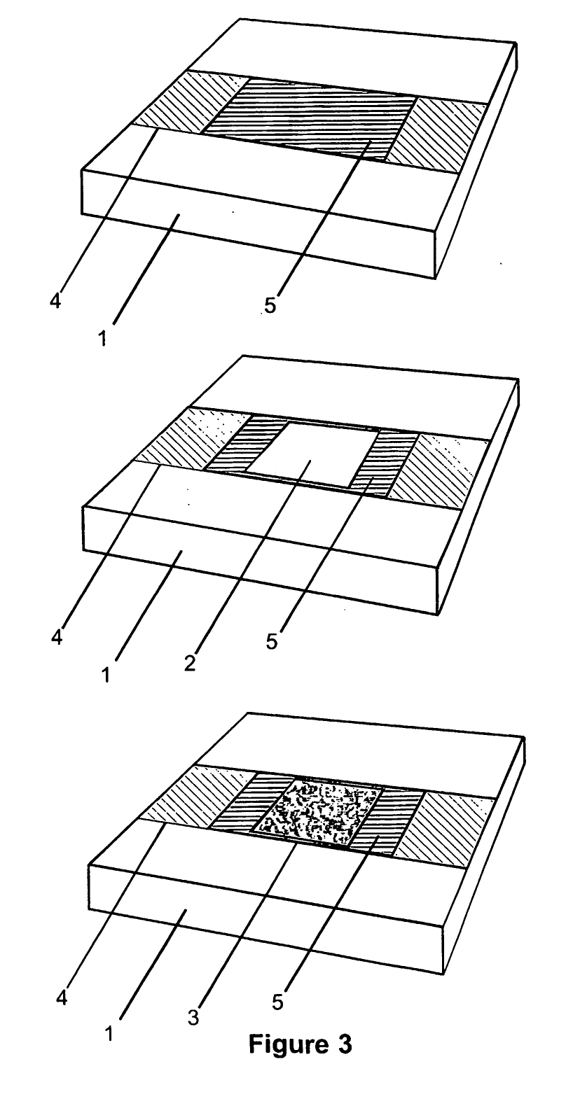

FIG. 3 shows a substrate on which is deposited a conductive track that will form a back contact electrode (cathode), followed by an intermediate electrically resistive layer disposed on top of a region of this conducting track, then a vanadium-containing precursor deposited on a region of this resistive layer and then heat treatment of the assembly to create vanadium-containing whiskers in the region where the precursor was disposed;

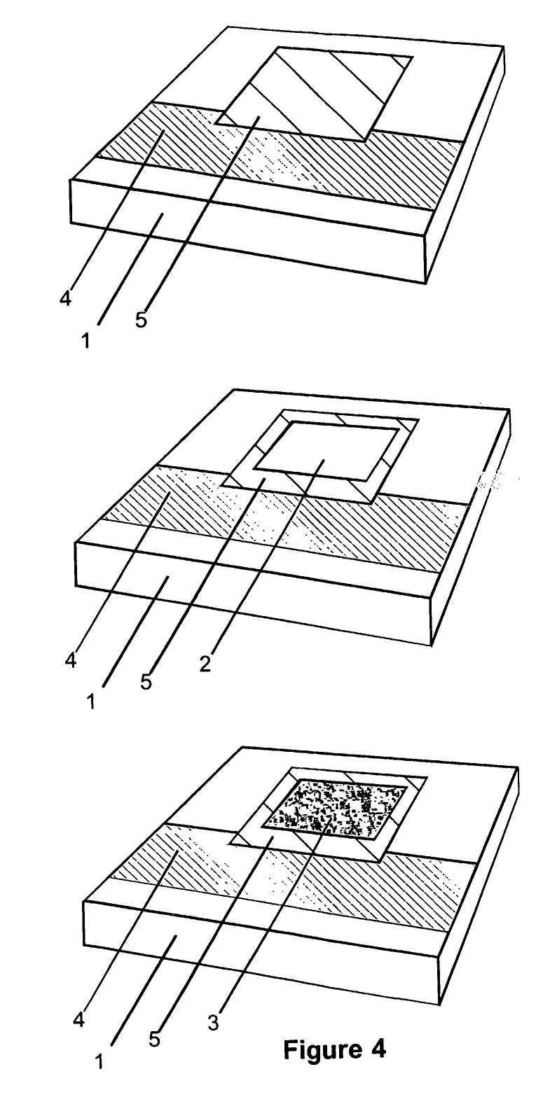

FIG. 4 shows a substrate on which is deposited a conductive track that will form a back contact electrode (cathode), followed by an intermediate electrically resistive layer disposed partly on top of a region of this conducting track so that it extends off to one side of the conducting track, then a vanadium-containing precursor deposited on a region of this resistive layer away from the electrode, and then heat treatment of the assembly to create vanadium-containing whiskers in the region where the precursor was disposed;

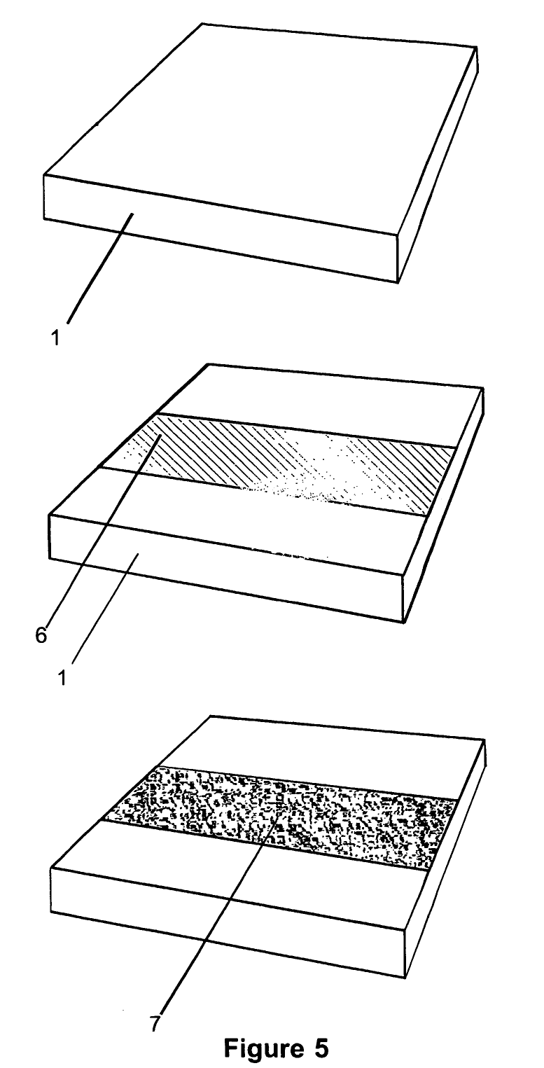

FIG. 5 shows a substrate on which is deposited a conductive track with vanadium-containing precursor that, on thermal treatment, will form both a back contact electrode (cathode) and vanadium-containing whiskers;

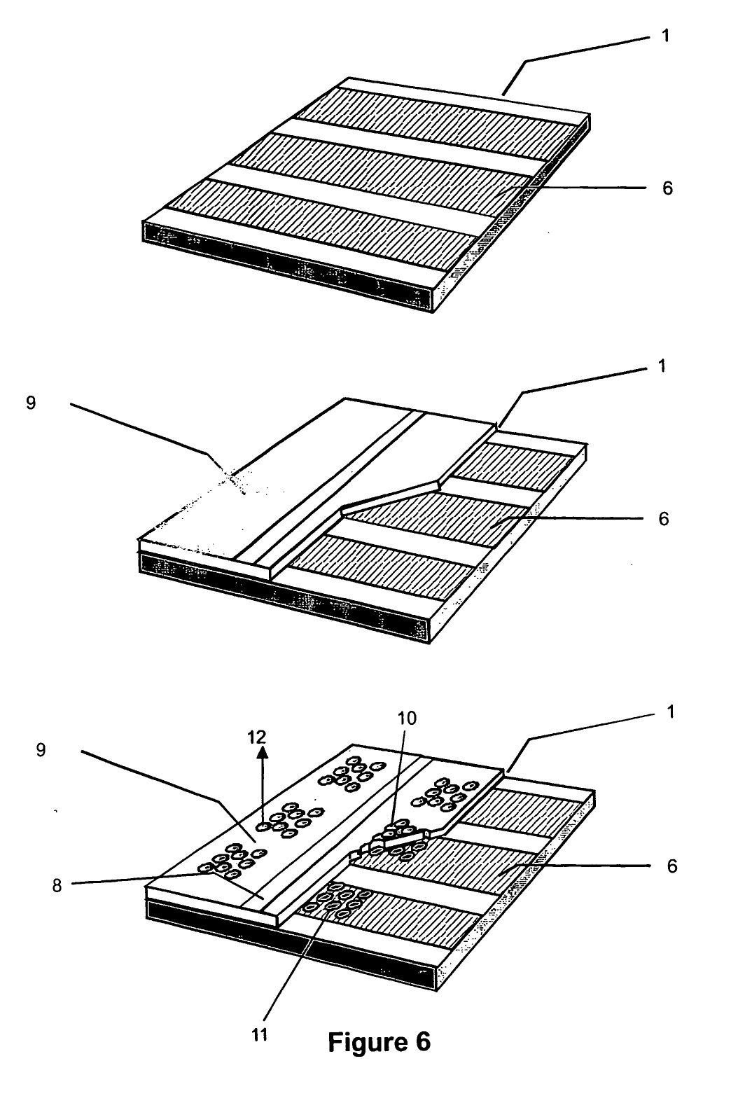

FIG. 6 illustrates one embodiment of the invention in which a vanadium-containing precursor, on a first thermal treatment, forms an adherent back contact electrode and, upon a subsequent heat treatment, allows vanadium-containing fibres to grow;

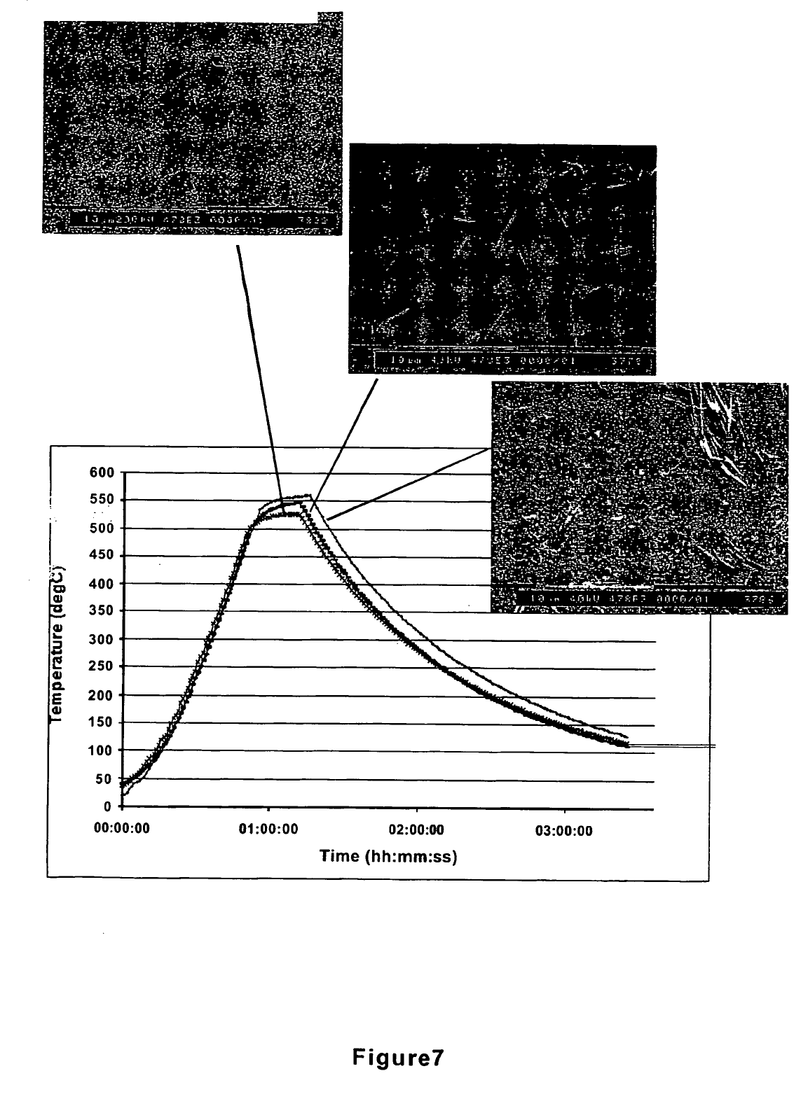

FIG. 7 shows a graph of three temperature profiles used to thermally treat a vanadium-containing precursor in air, with relevant scanning electron micrographs revealing the morphology of final vanadium-containing whiskers;

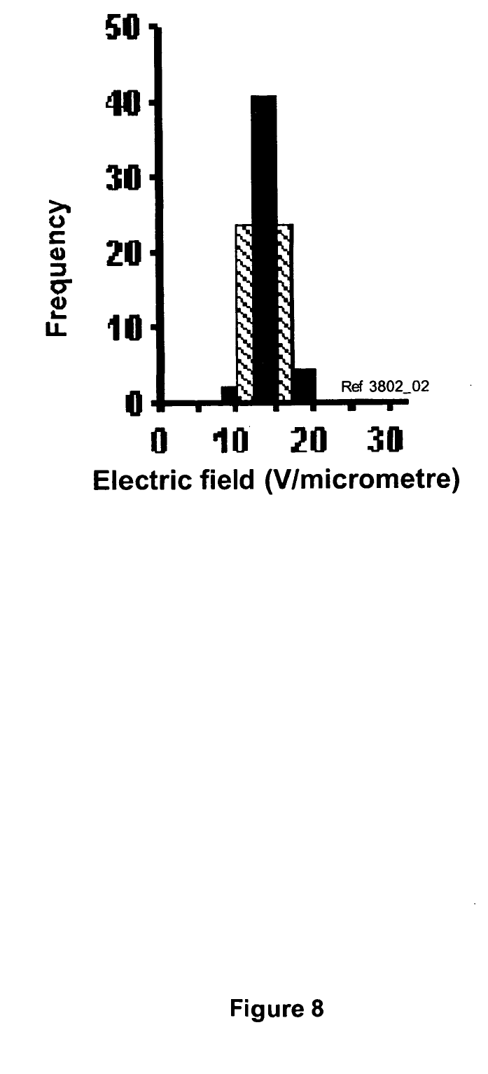

FIG. 8 shows a frequency histogram of field emission data obtained using a probe system; and

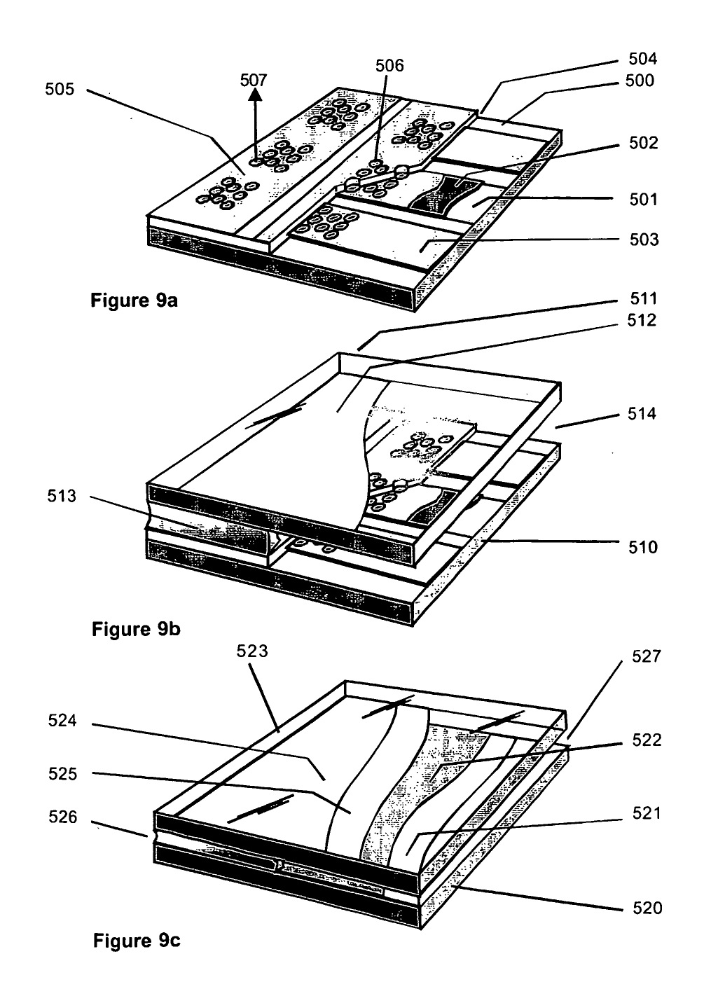

FIGS. 9a to 9c illustrate examples of devices that utilise examples of broad area field electron emitters.

In the figures, like reference numerals denote like or corresponding parts.

Vanadium oxide is a material that can exist in a number of different stoichiometries. These include VO₂, V₂O₃, and V₂O₅. In addition, the materials themselves have widely varying properties. V0₂ has a transition temperature that changes it from non-metallic (low temperature) to metallic, and V₂O₃ shows a similar transition with pressure, and a magnetic insulator to metal transition with temperature at ˜150K. In the metallic form, V₂O₃ has a resistivity of 3000 Ωcm and a high melting point of ˜2213K. V₂O₅ has semiconducting properties with a band-gap of 2.2 eV. It has a melting point at ˜963K. It is not surprising to learn that the complex physical properties of these materials are still not fully understood (Transition Metal Oxides, P.A. Cox, Oxford University Press, 1992, and Leisenberger et al.: J. Vac. Sci. Technol. A, 17, pp. 1743-1749 (1999)). However, vanadium oxides have found various technological applications, including optical switching coatings and optical storage thin films. The electrical properties of V₂O₅ ribbons derived using sol-gel processes have also been reported (Muster et al.:, Adv. Mater., 12, pp. 420-424 (2000)).

One method known in the art for making V₂O₅ is to heat vanadium residues with NaCl at about 850° C. in air to create NaVO₃. This can be oxidised to V₂O₅ by acidification. A disadvantage with this process is that it is not compatible with borosilicate glass or high strain point glass substrates which are commonly used for inexpensive large area devices such as displays. However, it is compatible with refractory ceramic substrates such as alumina tiles or relatively high melting point metals such as copper.

Also of interest is the fact that vanadium oxide can grow in the form of a nanotube structure (H. -J. Muht et al.: Adv. Mater., 12, pp. 231-234 (2000)). In this paper it was highlighted that a vanadium oxide based nanotube system (VOhd x-NT) had advantages over CNTs because they could be produced using low temperature soft chemistry synthesis techniques. For example, alkyl amines and alkyl diamines can be reacted with vanadium (v) alkoxide to create gram quantities of well aligned highly crystalline nanotubes. These materials have been investigated for applications as electrodes in lithium batteries (M.E. Spabr et al.: J. Electrochem. Soc. 146, pp. 2780-2783 (1999), but have poor temperature stability, collapsing to an amorphous vanadium oxide above 250° C.

One aspect of the present invention is the use of thermally grown, vanadium-containing fibres as a field electron emitting material. For example, the rod-like morphology of V₂O₅ and its semiconducting properties provide for a useful field electron emitting material operable at low macroscopic threshold fields. By disposing such material on a conductor it is possible to make a good field electron emitter.

A further aspect of the present invention provides for a method of producing useful vanadium compound emitter structures by printing. Tuck, Taylor and Latham (UK Patent 2 304 989) proposed a printable route to producing an area field emitter using an ink that when fired produces an emitting surface comprising a dispersion of conducting or semiconducting particles dispersed in a dielectric matrix. In an improvement of this, according to one embodiment of the present invention, a route to achieving a printed vanadium-containing area emitter is to use a vanadium-containing precursor (such as vanadium residues, a vanadium sol-gel, or vanadium naphthenate oxide) in a vehicle suitable for printing.

Suitable screen-printing formulations that do not contain high quantities of particles to control the rheology have been taught in WO 02/03413, and can be applied to these materials.

However, formulations can be derived more suited to other application methods, such as ink-jet printing, painting, and dip-coating.

FIG. 1 shows how desired electron emitting whiskers in the form of fibres are produced by disposing the vanadium-containing precursor 2 in required regions of the substrate 1, such as borosilicate glass, and thermally treating the object. An example of a thermal treatment is to fire in air at 550° C., which is compatible with the glass substrate 1. By controlling the time of the thermal treatment, it is possible to grow vanadium-containing fibres 3 of a controlled length. An example is to heat the material up to temperature over a period of 1 hour and to hold the sample at 550° C. for 20 minutes before allowing it to cool back to room temperature over a period of about 2 hours. This example gives fibres of several micrometers in length.

In addition, it is possible to vary the concentration of vanadium additive in the precursor to control the site density and morphology of the fibres that grow from the printed layer. The chemical composition of the substrate on which the precursor is disposed can also be important. We have found that borosilicate glass is an advantageous substrate to use because of its composition, including sodium and boron content. Where the substrates does not contain such advantageous materials, or an overlying layer such as an electrode provides a barrier layer between the precursor and the substrate, these materials can be added directly to the precursor or an intermediate layer on which the precursor is to be disposed.

As shown in FIG. 2, such an approach can be used to grow a vanadium-containing emitter 3 directly on the cathode electrodes 4 of a device, to allow the emitter to be contacted and addressed electrically. FIG. 3 shows that, in addition, the precursor 2 can be applied to an electrically resistive film 5 that acts as a ballast resistor to help regulate current and hence improve uniformity of the emitting material 3. An alternative arrangement for this is shown in FIG. 4, in which the precursor 2 is offset so that a lateral resistor is formed by electrically resistive film 5. Note that additives that catalyse the reaction, such as sodium or boron as disclosed above, may be incorporated in the emitter precursor 3, in the electrodes 4 or in the intermediate layer that also serves as a resistive film 5.

A further embodiment provides a method of printing a vanadium precursor and a cathode electrode in a single stage, thus reducing the number of process steps. This is illustrated in FIG. 5, in which a conducting precursor 6 containing the vanadium emitter precursor is deposited on the substrate 1. This is then thermally treated to generate a conductive film and the vanadium-containing emitter material 7.

An example of such an embodiment is the use of a liquid bright (or resinate) gold, palladium or platinum with the vanadium precursor added. These bright metal compounds are based on an organometallic compound of gold, palladium or platinum in which a number of trace metals and compounds have been added. They are widely used in the pottery and glass industries for decorative coatings. The metallic layer is formed by painting or printing the material onto a substrate and then firing the object in air at temperatures between 480° C. and 920° C., at which point the organometallic compound decomposes to yield pure metal films of 100 to 200 nanometers thick. The function of the additives is to control the grain size of the gold and to promote adhesion. Vanadium compounds are one of example of a class of compatible additives that under special controlled thermal conditions yield vanadium-containing fibres growing from the surface. By ensuring a sufficient quantity of vanadium is present, a plethora of fibres grow under the firing conditions, which are also compatible with forming and retaining the electrically conducting metallic film.

The advantage of using such a precursor is that the single printing stage and single firing stage provides for the self-assembly of both a printed cathode electrode and a printed emitter structure. This is a further improvement on the low-cost field effect device (FED) structures taught previously by Tuck et al. (GB 2 330 687), although it could also be combined with the more conventional triode structures fabricated using sputtering and plasma deposition processes, for example Chalamala & Gnade: IEEE Spectrum, April, pp. 42-51 (1998). Whiskers grown in this way are also stable at the temperatures required to air-bake and seal a field emission display. This is in contrast to the VOₓ-NTs discussed earlier.

A further advantage of this approach is the possibility to define the cathode tracks and fire them in air using conditions suitable to form the gold film and adhere it to the substrate, but unsuitable to promote the growth of the desired vanadium-containing emitter structure. Such conditions can be achieved by careful control of the peak temperature and dwell time. This process is illustrated in FIG. 6, in which a cathode and emitter precursor 6 is applied to the substrate 1 and thermally treated to give an adherent film. An overlying device structure of gate dielectric 8 and gate electrodes 9 are then deposited, and then emitter holes 10 are etched back through the device to reveal the underlying cathode electrodes and unactivated vanadium precursor. There then follows a further thermal treatment stage, so that the desired vanadium-containing fibres 11 can grow at the bottom of the holes, which is precisely the preferred location for electron emission 12. In addition, this firing stage can be combined with an air-bake and sealing stage used to form a finished device assembly. This further reduces the number of process steps.

In such a process, it may be advantageous to apply an intermediate layer over the printed vanadium-containing material, to serve as an etch stop during the subsequent steps of forming the emitter holes.

In a variant of the above method, a vanadium precursor is printed in a single stage with an intermediate resistive layer that serves as a ballast resistor. This is achieved by incorporating a vanadium-containing precursor with a material used to form the resistive layer. The method is generally analogous to that in which vanadium precursor and cathode electrode are printed in a single stage. The resistive layer may or may not be disposed upon a conductive substrate. As before, the growth of the vanadium whiskers may be delayed until later, in the sequence of fabricating the device structure.

Good control of the growth of these fibres ensures that the length and area density of the vanadium-containing fibres are compatible with the gate cell height and diameter in a device. FIG. 7 shows three temperature profiles that may be used to fire a vanadium-containing precursor in air. The corresponding scanning electron micrographs illustrate the differences in whisker length and density as a result of these conditions. The micrograph corresponding to the lowest peak temperature shows a few short fibres, the intermediate micrograph illustrates longer but dispersed fibres, and the micrograph corresponding to the highest temperature illustrates denser tufts of whiskers. This ability to tailor the morphology of the whiskers is extremely important if the emitting structure is to remain within the gate hole and not short-circuit to the gate electrodes. It is also important to prevent the fibres projecting beyond the top of the gate hole and becoming influenced predominantly by the electric field from the anode.

To illustrate that such vanadium-containing whiskers do give good field electron emitting properties, FIG. 8 shows a frequency histogram of initiation field (black bars) and subsequent threshold field (hatched bars) for forty-nine separately tested areas on a sample of vanadium-containing whiskers. The data was obtained by using a probe with an effective diameter of ˜350 micrometres scanned 50 micrometres above the surface of the sample in a computer-controlled vacuum test system. This system has been described by Burden et al. (J. Vac. Sci. Technol. B 18, pp 900-904 (2000)). This data shows that the macroscopic field required to initiate and operate these emitters at a current of 10 nA was in each case below 20 volts/micrometer, and that the spread between the minimum and maximum subsequent initiation fields was 6 volt/micrometer.

Preferred embodiments of the present invention aim to provide cost-effective broad area field emitting materials and devices that may be used in devices that include (amongst others): field electron emission display panels; high power pulse devices such as electron MASERS and gyrotrons; crossed-field microwave tubes such as CFAs; linear beam tubes such as klystrons; flash x-ray tubes; triggered spark gaps and related devices; broad area x-ray sources for sterilisation; vacuum gauges; ion thrusters for space vehicles; particle accelerators; ozonisers; and plasma reactors.

Examples of some of these devices are illustrated in FIGS. 9a, 9b and 9c.

FIG. 9a shows an addressable gated cathode as might be used in a field emission display. The structure is formed of an insulating substrate 500, cathode tracks 501, vanadium-containing emitter layer 502, focus grid layer 503 electrically connected to the cathode tracks, gate insulator 504, and gate tracks 505. The gate tracks and gate insulators are perforated with emitter cells 506. A negative bias on a selected cathode track and an associated positive bias on a gate track cause electrons 507 to be emitted towards an anode (not shown). Here, the focus grid layer 503 may serve as an etch stop layer, as mentioned above. Alternatively, the layer 503 may serve solely as an etch stop layer, in which case, the layer 503 may be electrically conductive, insulating or semiconducting.

The reader is directed to our patent GB 2 330 687 B for further details of constructing Field Effect Devices.

The electrode tracks in each layer may be merged to form a controllable but non-addressable electron source that would find application in numerous devices.

FIG. 9b shows how the addressable structure 510 described above may be joined with a glass fritt seal 513 to a transparent anode plate 511 having upon it a phosphor screen 512. The space 514 between the plates is evacuated, to form a display.

Although a monochrome display has been described, for ease of illustration and explanation, it will be readily understood by those skilled in the art that a corresponding arrangement with a three-part pixel may be used to produce a colour display.

FIG. 9c shows a flat lamp using one of the above-described materials. Such a lamp may be used to provide backlighting for liquid crystal displays, although this does not preclude other uses, such as room lighting.

The lamp comprises a cathode plate 520 upon which is deposited a conducting layer 521 and a vanadium-containing emitting layer 522. Ballast layers as mentioned above (and as described in our other patent applications mentioned herein) may be used to improve the uniformity of emission. A transparent anode plate 523 has upon it a conducting layer 524 and a phosphor layer 525. A ring of glass fritt 526 seals and spaces the two plates. The interspace 527 is evacuated.

The operation and construction of such devices, which are only examples of many applications of embodiments of this invention, will readily be apparent to those skilled in the art. An important feature of preferred embodiments of the invention is the ability to print the field electron emission material, when formed as an ink, as an electrode pattern, thus enabling complex multi-emitter patterns, such as those required for displays, to be created at modest cost. Furthermore, the ability to print enables low-cost substrate materials, such as glass to be used; whereas micro-engineered structures are typically built on high-cost single crystal substrates. In the context of this specification, printing means a process that places or forms an emitting material in a defined pattern. Examples of suitable processes are (amongst others): screen printing, Xerography, photolithography, electrostatic deposition, spraying, ink jet printing and offset lithography.

Once vanadium-containing field emission material has been applied as an ink, growth of the vanadium-containing fibres may take place during subsequent curing of the ink. For example, this may take place conveniently during a heat treatment step in an assembly process of a respective device.

Instead of using vanadium, whiskers can be grown at locations on various metal oxides deposited on a substrate, to provide emission sites at those locations.

Alternatives to oxides of metals include silicides, nitrides, silicates, carbides, borides, sulphides and titanates.

Devices that embody the invention may be made in all sizes, large and small. This applies especially to displays, which may range from a single pixel device to a multi-pixel device, from miniature to macro-size displays.

Preferred embodiments of the invention provide emitting materials that are designed deliberately to have a significant density of emitting sites, as opposed to accidental and unwanted sparse inclusions of sporadic emitters, as have been noted from time to time in the vacuum insulating field, for example.

In preferred embodiments of the invention, the distribution of emitting sites over the field electron emission material is preferably random, with an average density of at least 10² cm⁻², 10³ cm⁻², 10⁴ cm⁻² or 10⁵ cm⁻². The distribution is also substantially uniform and, preferably, when using a circular measurement area of 1 mm in diameter, is substantially Binomial or Poisson. The uniformity may be such that the density of the emitting sites in any circular area of lmm diameter does not vary by more than 20% from the average density of distribution of sites for all of the field electron emission material. The distribution of the emitting sites over the field electron emission material may have a uniformity such that there is at least a 50% probability of at least one emitting site being located in any circular area of 4 μm or 10 μm diameter.

In this specification, the verb “comprise” has its normal dictionary meaning, to denote non-exclusive inclusion. That is, use of the word “comprise” (or any of its derivatives) to include one feature or more, does not exclude the possibility of also including further features.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-58. (canceled)

59. A method of creating a field electron emission material, comprising the steps of coating a substrate with an ink containing a metal compound or precursor therefor, the compound being selected from the group comprising oxides, silicides, nitrides, silicates, carbides, borides, sulphides and titanates; and curing the ink in such conditions as to grow whiskers of the metal compound at locations on said substrate, thereby to create a plurality of emission sites at said locations.

60. A method according to claim 59, wherein said metal compound or precursor therefor is in the form of particles.

61. A method according to claim 59, wherein said curing step includes heating said ink.

62. A method according to claim 61, wherein said curing step includes heating said ink to a temperature in the range 100 to 1000° C.

63. A method according to claim 61 wherein said curing step includes heating said ink to a temperature in the range 300 to 800° C.

64. A method according to claim 61, wherein said curing step includes heating said ink to a temperature in the range 500 to 550° C.

65. A method according to claim 62, wherein said curing step includes maintaining said temperature for a period in the range 5 to 300 minutes.

66. A method according to claim 62, wherein said curing step includes maintaining said temperature for a period in the range 5 to 60 minutes.

67. A method according to claim 62, wherein said curing step includes maintaining said temperature for a period in the range 10 to 30 minutes.

68. A method according to claim 62, wherein said coating step includes printing said ink directly or indirectly onto said substrate.

69. A method according to claim 68, wherein said coating step includes printing said ink onto a cathode track on said substrate.

70. A method according to claim 68, wherein said coating step includes printing said ink onto a resistive layer on said substrate.

71. A method according to claim 59, wherein said ink contains an organometallic compound and said metal compound or precursor therefor.

72. A method according to claim 71, wherein said organometallic compound contains one or more metal selected from gold, palladium and platinum.

73. A method according to claim 71, wherein said ink contains 0.01 to 10 wt % of said metal with respect to the metal part of the organometallic compound.

74. A method according to claim 71, wherein said ink contains 0.5 to 5 wt % of said metal with respect to the metal part of the organometallic compound.

75. A method according to claim 71, wherein said ink contains 0.8 to 2.5 wt % of said metal with respect to the metal part of the organometallic compound.

76. A method according to claim 59, wherein said metal compound comprises a naphthenate oxide.

77. A method according to claim 59, wherein said ink contains material to create both said emission sites and a layer upon which said emission sites are disposed.

78. A method according to claim 77, wherein said layer provides an electrode.

79. A method according to claim 77, wherein said layer provides a resistive layer to serve as a ballast resistor.

80. A method according to claim 77, wherein said curing step comprises processing the ink under such conditions as to create said layer and said emission sites concurrently.

81. A method according to claim 77, wherein said curing step comprises processing the ink under first conditions such as to create said layer and subsequently under second conditions such as to create said emissions sites on said layer.

82. A method according to claim 59, wherein said curing step is carried out concurrently with a sealing step in which the field electron emission material is sealed within a field electron emission device.

83. A method according to claim 59, wherein said emission sites have an average density of at least 10² cm⁻².

84. A method according to claim 59, including the step of incorporating an additive to catalyse the formation of said metal compound whiskers.

85. A method according to claim 84, wherein said additive comprises sodium or boron.

86. A method according to claim 59, wherein said metal comprises vanadium.

87. A method according claim 59, wherein said metal compound or precursor therefor is in the form of a sol-gel.

88. A method according to claim 59, wherein the distribution of said sites over the field electron emission material is random.

89. A method according to claim 59, wherein said sites are distributed over the field electron emission material at an average density of at least 10³ cm⁻², 10⁴ cm⁻² or 10⁵ cm⁻².

90. A method according to claim 59, wherein the distribution of said sites over the field electron emission material is substantially uniform.

91. A method according to claim 90, wherein the distribution of said sites over the field electron emission material has a uniformity such that the density of said sites in any circular area of lmm diameter does not vary by more than 20% from the average density of distribution of sites for all of the field electron emission material.

92. A method according to claim 59, wherein the distribution of said sites over the field electron emission material when using a circular measurement area of 1 mm in diameter is substantially Binomial or Poisson.

93. A method according to claim 90, wherein the distribution of said sites over the field electron emission material has a uniformity such that there is at least a 50% probability of at least one emitting site being located in any circular area of 4 μm diameter.

94. A method according to claim 90, wherein the distribution of said sites over the field electron emission material has a uniformity such that there is at least a 50% probability of at least one emitting site being located in any circular area of 10 μm diameter.

95. A field electron emission material that has been created by a method according to claim 59.

96. A field electron emission device comprising a field electron emitter containing a field electron emission material according to claim 95, and means for subjecting said emitter to an electric field in order to cause said emitter to emit electrons.

97. A field electron emission device according to claim 96, comprising a substrate with an array of patches of said field electron emitters, and control electrodes with aligned arrays of apertures, which electrodes are supported above the emitter patches by insulating layers.

98. A field electron emission device according to claim 97, wherein said apertures are in the form of slots.

99. A field electron emission device according to claim 96, comprising a plasma reactor, corona discharge device, silent discharge device, ozoniser, an electron source, electron gun, electron device, x-ray tube, vacuum gauge, gas filled device or ion thruster.

100. A field electron emission device according to according to claim 96, wherein the field electron emitter supplies the total current for operation of the device.

101. A field electron emission device according to according to claim 96, wherein the field electron emitter supplies a starting, triggering or priming current for the device.

102. A field electron emission device according to according to claim 96, comprising a display device.

103. A field electron emission device according to according to claim 96, comprising a lamp.

104. A field electron emission device according to claim 103, wherein said lamp is substantially flat.

105. A field electron emission device according to claim 96, wherein said emitter is connected to an electric driving means via a ballast resistor to limit current.

106. A field electron emission device according to claim 97, wherein a ballast resistor is applied as a resistive pad under each said emitting patch.

107. A field electron emission device according to claim 96, wherein said emitter material and/or a phosphor is/are coated upon one or more one-dimensional array of conductive tracks which are arranged to be addressed by electronic driving means so as to produce a scanning illuminated line.

108. A field electron emission device according to claim 107, including said electronic driving means.

109. A field electron emission device according to claim 96, wherein said field emitter is disposed in an environment which is gaseous, liquid, solid, or a vacuum.

110. A field electron emission device according to claim 96, comprising a cathode which is optically translucent and is so arranged in relation to an anode that electrons emitted from the cathode impinge upon the anode to cause electro-luminescence at the anode, which electro-luminescence is visible through the optically translucent cathode.
